(19) United States
(12) Patent Application Publication
(10) Pub. No.: US 2011/0258251 A1
(43) Pub. Date: Oct. 20, 2011

(54) Portable Power Distribution

(76) Inventor: Vito Antoci, Newport Beach, CA (US)

(21) Appl. No.: 12/769,530

(22) Filed: Apr. 28, 2010

Related U.S. Application Data
(60) Provisional application No. 61/326,175, filed on Apr. 20, 2010.

(51) Int. Cl. H02J 7/00; G06F 21/00; G06Q 30/00; G06F 15/16; G06Q 20/00

(52) U.S. Cl. 709/203; 705/14.49; 320/107; 320/108; 709/206; 726/34

(57) ABSTRACT

Some embodiments provide a systems, methods, and devices for providing power to recharge portable electronic devices through a distributed network of portable power stations that provide power on an advertising and/or fee basis. In some embodiments, the power distribution system includes a server and multiple distributed portable power stations. The server communicates with electronic devices in order to receive a request to unlock power from a particular power station. The server sends an advertisement and a code to unlock the particular power station. In some embodiments, the server process payment information and sends the unlock code. Each of the portable power stations includes multiple charging interfaces and a lockable power supply that is unlocked using the server provided code. When unlocked, the power station recharges batteries of any electronic devices that are connected to any of the charging interfaces of the power station.

### CLAIM OF BENEFIT TO RELATED APPLICATIONS

This application claims the benefit of U.S. Provisional Application 61/326,175, entitled “Portable Power Distribution”, filed Apr. 20, 2010.

### TECHNICAL FIELD

The present invention relates to systems, methods, and devices to distribute power to recharge electronic devices on an advertising and/or fee basis.

### BACKGROUND

Portable electronic devices play a central role in the business and recreational lives of people. Portable electronic devices provide users with on-demand access to a multitude of functionality including communication, entertainment, information, and computing as some examples. These devices provide such functionality without restricting the mobility of the user.

Some examples of portable electronic devices include mobile telephones, personal digital assistants (PDAs), laptop computers, portable music players, digital cameras, electronic gaming devices, and other battery operated devices. These devices are portable by virtue of the batteries that power the devices when on-the-go or away from a power source. However, the capacity of the batteries are limited and users often find themselves low on battery power due to excessive use, short battery life, forgetting to recharge the battery, or being away from a power source.

Many portable electronic devices store personal information and cannot be replaced when the battery runs out with a like kind device. One solution is to carry recharging equipment, such as a power adapter, to recharge the device. However, recharging equipment often involves (i) bulky adapters that are large or heavy, (ii) proprietary interfaces that can only be used to recharge a particular device and not other commonly carried devices, and (iii) incompatible specifications with electrical systems of different regions (i.e., different voltages 110V and 220V). Recharging equipment also requires that an available power source or power outlet be located nearby. In many areas where portable electronics are used (e.g., street, beach, airplane, park, etc.), power outlets are unavailable.

Some users purchase additional backup batteries to replace the primary batteries of the device in the event the primary batteries lose power. However, carrying extra batteries, like carrying recharging equipment, becomes cumbersome. Batteries for larger electronic devices (e.g., laptop computers) are heavy and large. Other devices operate using non-standard batteries which require the user to purchase different proprietary backup batteries for different devices. The user then has to ensure that the backup batteries contain sufficient charge to power the device. A further problem is that some devices do not have interchangeable batteries.

Accordingly, there is a need to provide portable power that can be used to recharge many of the most common portable electronic devices irrespective of the availability of a power outlet, the availability of recharging equipment, or the location of the device. There is further a need to provide such power in a cost-effective manner such that users of the devices receive power when most in need of power.

### SUMMARY OF THE INVENTION

Some embodiments provide systems, methods, and devices for providing power to recharge portable electronic devices through a distributed network of portable power stations that provide power on an advertising and/or fee basis. A server controls the advertisement distribution and fee collection and facilitates the distribution of power from a network of portable power stations.

Each power station includes a lockable power supply, a code input interface, and multiple recharging interfaces. Each of the recharging interfaces of the power station can connect to a different charging interface of a portable electronic device to recharge the device. Power from the power supply is unlocked based on codes that are entered into the code input interface. In some embodiments, the codes include a sequence of numbers that are encoded to specify a time and duration for the power station to unlock and provide power to the portable electronic device. Each power station includes logic to validate an entered code and to extract the time and duration parameters from the user entered code.

The unlock codes for each of the power stations are generated at the server. The server includes (i) logic for generating the unlock codes, (ii) interfaces and storage for content providers to submit and manage advertisements, (iii) scheduling logic to disseminate targeted advertisements, (iv) a payment processor to receive payments, and (v) interfaces and storage for maintaining a location directory that identifies a location for each of the portable power stations.

The server receives from a communication enabled portable electronic device (e.g., smartphone) a request for power from a particular power station. The request may be submitted wirelessly through wireless voice or data networks or through wired voice or data networks. The request is submitted through a server hosted website, text message, email, or by following a sequence of audio prompts. In some embodiments, the server requests and receives login information, selection of a desired charging duration, and payment information from the requesting device. The server disseminates to the requesting device at least one advertisement followed by an unlock code that unlocks the power supply of the particular power station.

The advertisement includes some combination of visual, textual, or auditory message that is embedded within a feature rich internet website, multimedia messaging service (MMS) message, text message, email, or audio message. Advertisements of different lengths or multiple advertisements may be disseminated to the user based on the desired amount of power from the power supply. For example, the server disseminates a ten second advertisement for unlocking one hour of power from the power station and two fifteen second advertisements for unlocking three hours of power from the power station. The server may disseminate targeted advertisements to the portable electronic device by identifying a location associated with the particular power station from the location database.

In some embodiments, the server provides one or more advertisements and an unlock code without receiving payment information from the requestor. In some embodiments, the server receives and processes payment information from the requestor and sends the unlock code without any advertisements.

### BRIEF DESCRIPTION OF THE DRAWINGS

In order to achieve a better understanding of the nature of the present invention a preferred embodiment of the systems, methods, and devices for providing power to recharge portable electronic devices through a distributed network of portable power stations that provide power on an advertising or fee basis will now be described, by way of example only, with reference to the accompanying drawings in which:

FIG. 1 illustrates a power distribution system in accordance with some embodiments.

FIG. 2 presents an exemplary message exchange for unlocking the flow of power at a particular power station.

FIG. 3 presents an example of the website hosted by the server.

FIG. 4 illustrates an example of the redirected website in accordance with some embodiments.

FIG. 5 illustrates components of the server and their interaction with third parties in accordance with some embodiments.

FIG. 6 presents a process for submitting advertisements to the server in accordance with some embodiments.

FIG. 7 conceptually illustrates the targeted advertising performed by the advertisement scheduler in accordance with some embodiments.

FIG. 8 illustrates the distributed system architecture of some embodiments that utilize a third party advertisement server.

FIG. 9 presents a process for distributing unlock codes on an advertising basis in accordance with some embodiments.

FIG. 10 presents a process for distributing unlock codes on a fee basis in accordance with some embodiments.

FIG. 11 presents a process performed by the code generator for generating an unlock code for a particular power station.

FIG. 12 illustrates an example of a request for an unlock code and an encoded unlock code generated by the code generator in accordance with some embodiments.

FIG. 13 presents a power station in accordance with some embodiments.

FIG. 14 presents the internal components of the power station in accordance with some embodiments.

FIG. 15 presents a process performed by the processor of the power station to unlock power in accordance with some embodiments.

FIG. 16 presents a process performed by the processor to validate an unlock code in accordance with some embodiments.

### DETAILED DESCRIPTION OF THE INVENTION

In the following detailed description of the invention, numerous details, examples, and embodiments of the systems, methods, and devices for recharging electronic devices through a distributed network of portable power stations that provide power on an advertising or fee basis are set forth and described. However, it will be clear and apparent to one skilled in the art that these systems, methods, and devices are not limited to the embodiments set forth and that these systems, methods, and devices may be practiced without some of the specific details and examples discussed.

Portable electronic devices including mobile telephones, personal digital assistants (PDAs), laptop computers, portable music players, digital cameras, electronic gaming devices, and other battery operated electronic devices rely on batteries for their portability. When on-the-go or away from a power source, the batteries provide up to a few hours of operation until the batteries have to be replaced, recharged, or the device is provided constant power through a power adapter of the device that is connected to a power outlet.

In many instances, users do not carry extra batteries or the power adapter when away from the home, office, or other location. Furthermore, a power adapter is useless when there are no nearby power outlets or the device is in a foreign location that has an electrical system that is incompatible with the power specifications of the device or power adapter.

Accordingly, some embodiments provide systems, methods, and devices for providing power to recharge portable electronic devices through a distributed network of portable power stations that provide power on an advertising and/or fee basis. Some such embodiments recharge the portable electronic device irrespective of the location of the device or whether the recharging equipment associated with the device (e.g., power adapter or necessary wiring) is readily available.

I. Power Distribution System

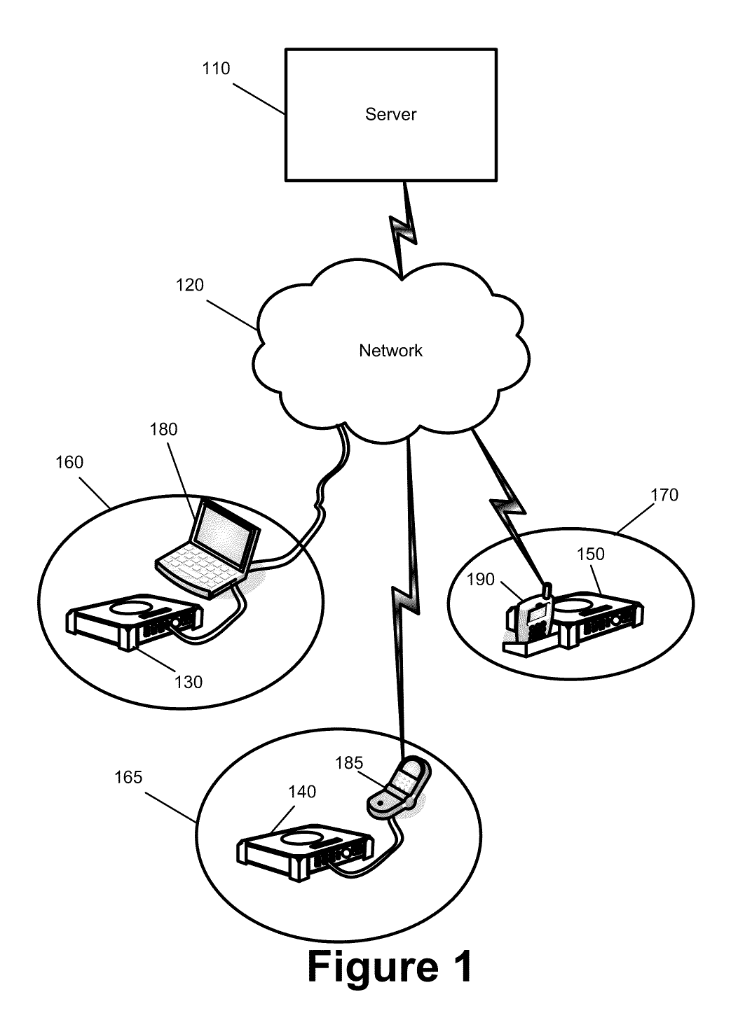

FIG. 1 illustrates a power distribution system in accordance with some embodiments. The power distribution system includes server 110, network 120, and a distributed set of portable power stations 130, 140, and 150. Each power station 130, 140, and 150 is located in a distinct region (e.g., regions 160, 165, and 170) from the other power stations though more than one power station may be included in any particular region. Each power station 130, 140, and 150 is assigned a unique identifier which is displayed on the device along with instructions for how to access power from the power station through the server 110. In some embodiments, the unique identifier identifies a region in which the power station is located. A region includes a business (e.g., hotel, coffee shop, etc.), location (e.g., park), or other area (e.g., city, state, municipality, zip code).

The power stations 130, 140, and 150 are docked on a docking station when not in use. The docking station recharges the power supply or battery of the power station. When the power station is needed to recharge a portable electronic device, the power station is removed from the docking station and brought to the device.

One of several charging interfaces of the power station can connect to charging interfaces of one or more devices in order to recharge the device. As shown, a portable electronic device (e.g., devices 180, 185, 190) is connected to each power station 130, 140, and 150 using one of several different interfaces of the power station. Through the connected interface, the power station provides power to recharge the connected device.

The interfaces include wired and wireless interfaces. In some embodiments, the wired interfaces include one or more ribbons that feed power from the power station to one or more docking ports located on a side of the power station. Each docking port contains a particular charging interface of a device (e.g., mini-USB) and a cradle to support the device when charging. The wired interfaces may also include a set of retractable cords each with a different interface connector at the end. The wireless charging interface includes an induction interface by which power is wirelessly transmitted to the battery of a portable electronic device.

In some embodiments, each power station 130, 140, and 150 provides a predetermined duration (e.g., twelve minutes) of free power before the flow of power is locked by the power station. To unlock the flow of power further, an unlock code must be entered on a code entry keypad of the power station.

Unlock codes are generated by the server 120. A portable electronic device requests an unlock code from the server 110 through the network 120. The request is conducted using the portable electronic device or some other communication enabled device that submits the request on behalf of the portable electronic device that needs to be recharged.

The network 120 includes any voice or data network. For example, network 120 includes the Internet, cellular voice networks (e.g., CDMA, TDMA, GSM, etc.), cellular data networks (GPRS, WiMAX, 3G and 4G data networks, etc.), messaging services, 802.11 based wireless networks, plain old telephone service (POTS), and other such communication networks.

The request may be submitted through a website managed by the server 110, a text message to the server 110, an email to the server 110, or by calling a particular number and following a series of audio prompts provided by the server 110. The request identifies a particular power station. The server 110 then requests the user to provide login information, select a duration for recharging, and optionally enter payment information before sending to the portable electronic device an unlock code that is embedded within an advertisement.

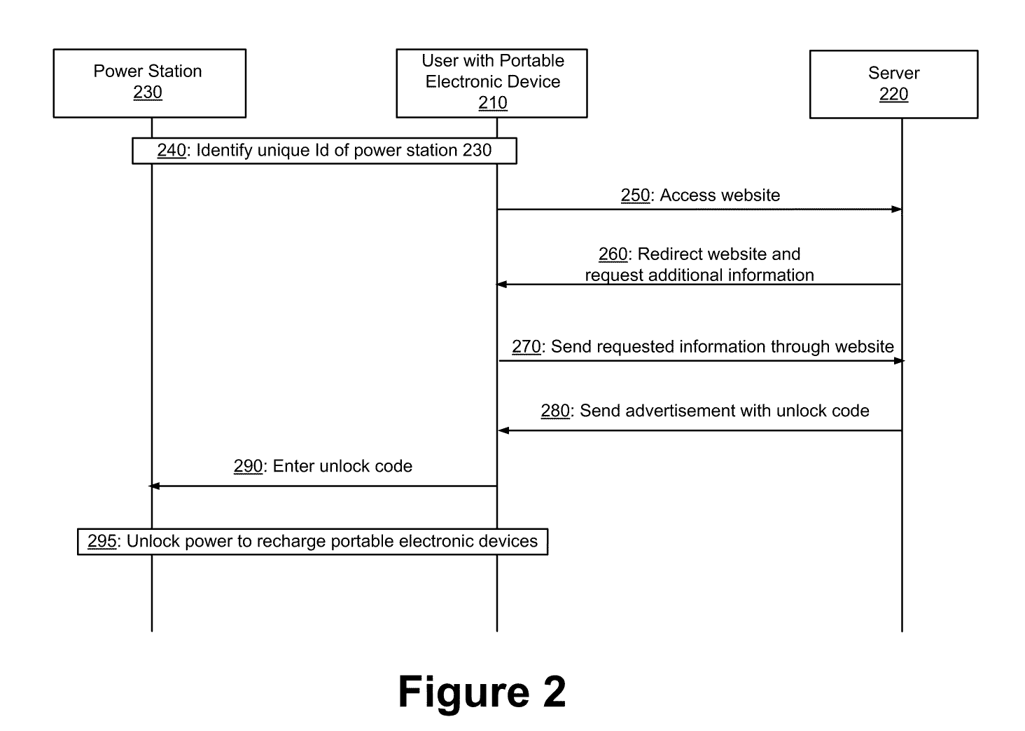

FIG. 2 presents an exemplary message exchange for unlocking the flow of power at a particular power station. The message exchange is conducted between a portable electronic device 210, server 220, and a particular power station 230.

To initiate a request to unlock power from the power station 230, the user of the portable electronic device 210 selects the particular power station 230 as the power station to recharge the portable electronic device 210. Imprinted on the particular power station 230 are instructions for how to unlock the power. The instructions may include a website address to access from the web browser of the portable electronic device 210, a number to send a text message based request to, or a number to dial in order to receive a set of audio prompts to unlock the device. The instructions also specify the unique identifier assigned to the particular power station 230 to identify the particular power station 230 to the server 220. For purposes of this example, it is assumed that the request is submitted by accessing a website hosted by the server 220.

The user identifies (at 240) the unique identifier assigned to the power station 230 and accesses (at 250) the website hosted by the server 220. When the portable electronic device 210 is not equipped with communication functionality (e.g., music player), another communication enable device may be used to submit the request on behalf of the portable electronic device 210.

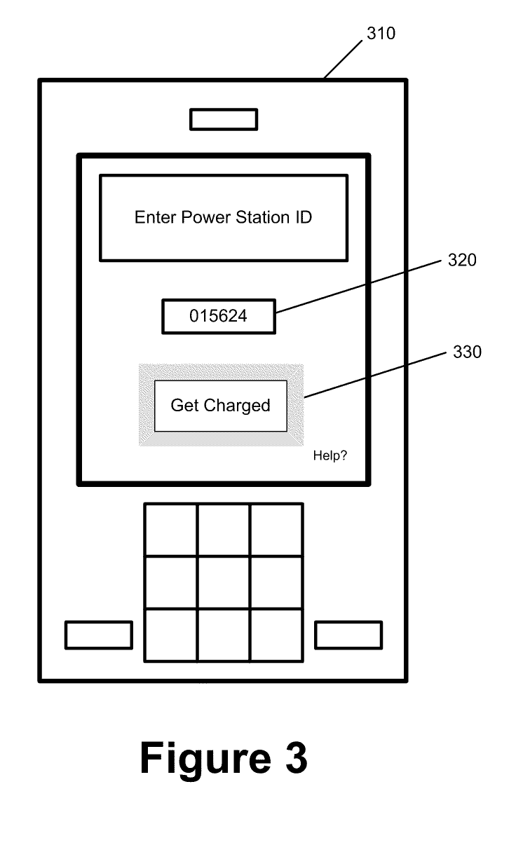

FIG. 3 presents an example of the website hosted by the server 220. The website is displayed on a display of a smartphone 310. The website contains a field 320 for the user to enter the unique identifier of the particular power station 230 and a button 330 to proceed.

In some embodiments, the server 220 receives the input and redirects the browser of the portable electronic device 210 to another website to request (at 260) additional information from the user. In some embodiments, the server requests (at 260) the user to enter login information (e.g., username and password) to identify the user, select a duration to unlock the power station 230 for recharging, and optionally to enter payment information.

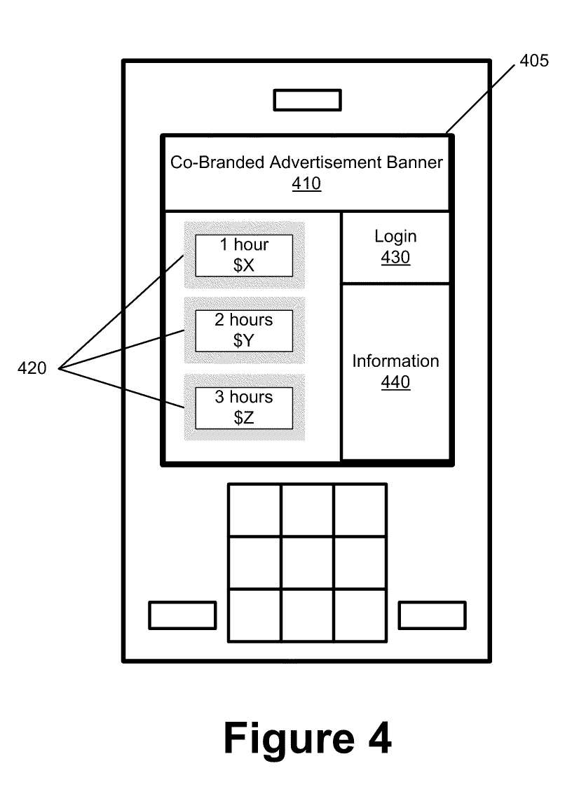

FIG. 4 illustrates an example of the redirected website 405 in accordance with some embodiments. As shown, the website 405 includes an advertisement banner 410, selection buttons 420 to specify a charging duration and the corresponding fee, login field 430, and other information fields 440. The user provides the requested information and submits the response (at 270) through the website.

In some embodiments, the website 405 is customized based on the power station unique identifier entered on the website of FIG. 3 above. The unique identifier identifies a particular location where the power station is hosted. Accordingly, the website 405 may be cobranded with advertisements, goods, services, and promotions for a business at the particular location. For example, if the power station is located at a particular hotel, the unique identifier allows some embodiments to customize the website 405 with special room rate promotions, spa deals, and hotel activities exclusive to the particular hotel.

It should be apparent that in some embodiments the website 405 includes additional or fewer fields that those depicted in FIG. 4. For example, the login field 430 may be presented on a later website after selection of a charging duration. Moreover, the website 405 may include a payment field though one may not be necessary when payment information is stored with a user account that is accessed using the login field 430. Additional websites may be presented after the website 405 in order to provide games, trivia, or other information to the user.

In some embodiments, the portable electronic device 210 may submit the request to unlock power from the particular power station 230 using alternate means of communication other than the web browser. For example, the request may be submitted using one or more text messages. An initial text message may be sent from the portable electronic device 210 to the server 220 with the unique identifier of the particular power station 230. A subsequent text message sent from the server 220 to the portable electronic device 210 may request additional information such as the login information or duration.

Upon receiving the information from the portable electronic device 210, the server 220 processes the information. In some embodiments, the processing includes validating the login information and billing a charge account of the user. Billing may occur using credit card information provided by or previously stored by the user, charging a room account of a hotel client, or by receiving a promotion code.

The server 220 selects one or more advertisements based on the user provided information and generates an unlock code. The server 220 embeds the unlock code at the end of the one or more selected advertisements. The server 220 sends (at 280) the selected one or more advertisements with the unlock code to the device 210. In some embodiments, the advertisements are sent directly through the website to be displayed on the portable electronic device 210, though alternate means of dissemination may include sending an MMS message, text message, or audio message. It should be apparent to one of ordinary skill in the art that in some embodiments the unlock code may be sent separate from the advertisement. In some such embodiments, the unlock code is presented after the advertising message.

The advertisements provide compensation to the power distribution system operator for operating the power stations and power distribution service. Specifically, the advertisements generate revenue directly from the advertisers, through the sale of goods and services promoted by the advertisements, or from referrals provided through the advertisements. Additionally, the proprietor of the power station may similarly be compensated through the advertisements for hosting the power station and providing a power distribution site.

The user receives the unlock code at the end of the advertisement, the user enters (at 290) the code on an input entry of the power station 230. The power station 230 begins providing (at 295) power for a specified duration to recharge the device 210 and any other devices connected to the charging interfaces of the power station 230. When the specified duration expires, the power station locks the flow of power preventing further recharging of the devices.

II. Server

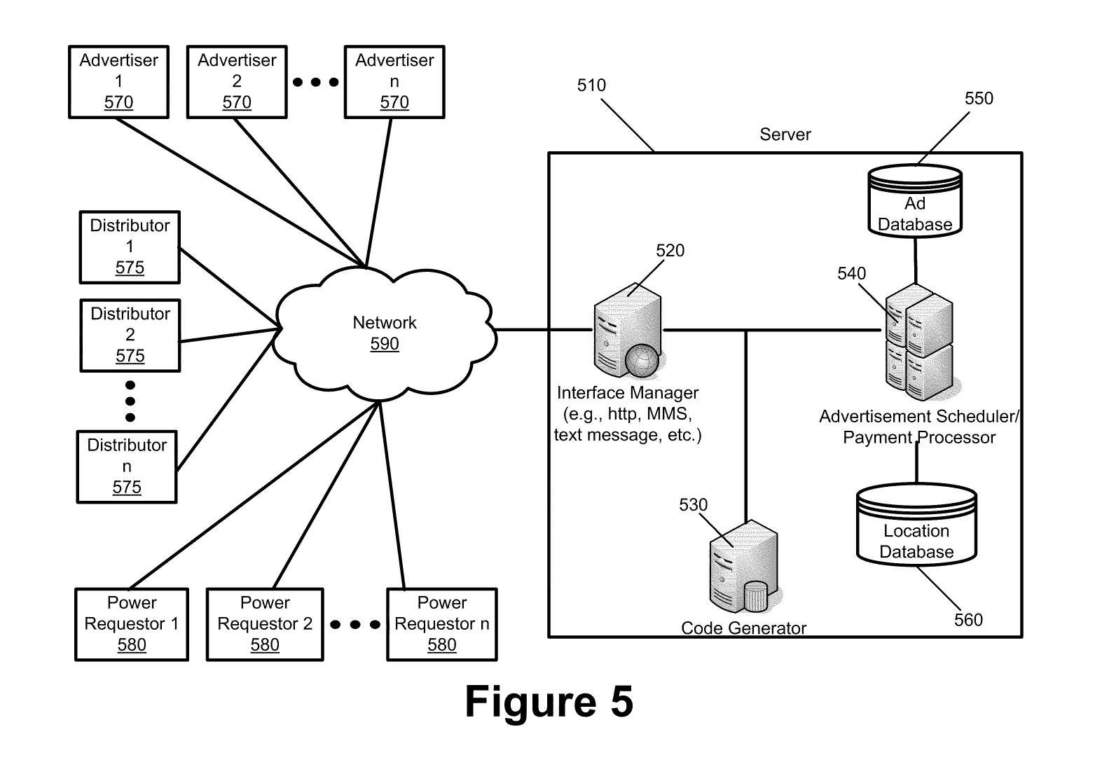

FIG. 5 illustrates components of the server 510 and their interaction with third parties in accordance with some embodiments. The server 510 includes an interface manager 520, code generator 530, advertisement scheduler and payment processor 540, advertisement database 550, and location database 560.

It should be apparent to one of skill in the art that the components of the server 510 (e.g., 520, 530, 540, 550, and 560) may include physical machines or logical components that are implemented on one or more physical machines. The physical machines may reside at a single location. Alternatively, the physical machines may reside at multiple physical locations whereby intercommunication between the machines is facilitated by the network 590.

The interface manager 520 acts as a point of contact for advertisers 570, distributors 575, and power requestors 580. Advertisers 570 include third parties that submit advertisements to be disseminated by the server 510. Distributers 575 include proprietors of the power stations and other parties that are purchasing, leasing, or hosting a power station. Power requestors 580 include users with portable electronic devices that need to recharge their devices.

In some embodiments, the interface manager 520 provides interactive interfaces to access services of the power distribution system. The interface manager 520 receives messages from the advertisers 570, distributors 575, and power requestors 580 and forwards the messages to either the code generator 530, advertisement scheduler and payment processor 540, or both. The interface manager 520 also sends messages received from the code generator 530 or advertisement scheduler and payment processor 540 to the advertisers 570, distributors 575, and power requestors 580.

The interface manager 520 provides interactive web pages that are accessible through the network 590 by any browser equipped device. Additionally, the interface manager 520 of some embodiments provides email, text messaging services, MMS services, and audio prompts as other forms of interactive interfaces through which advertisers 570, distributors 575, and power requestors 580 can access the services of the power distribution system of some embodiments.

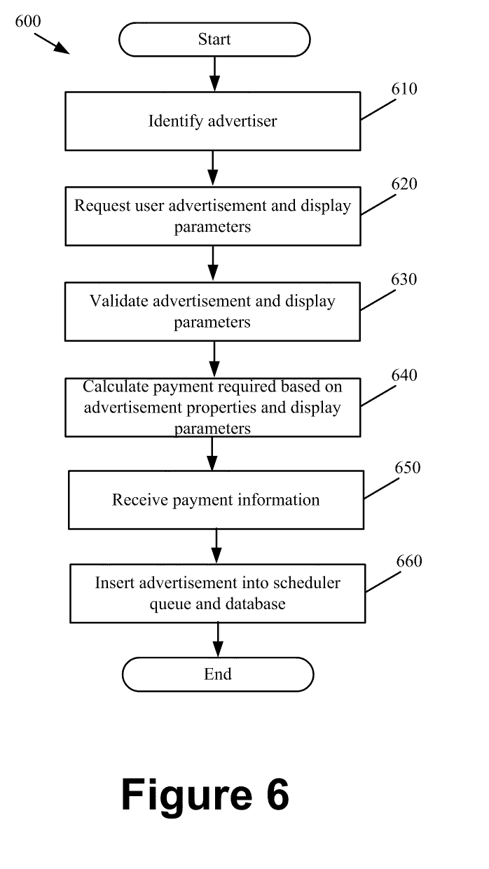

Advertisers 570 access the web pages to submit and manage advertisements that are disseminated to power requestors 580. The interface manager 520 presents the necessary web pages or other interfaces through which the advertisers 570 submit their advertisements and display parameters. The advertisements and display parameters are passed to the advertisement scheduler 540 and the advertisement database 550. FIG. 6 presents a process 600 for submitting advertisements to the server 510 in accordance with some embodiments.

The process 600 begins by the interface manager 520 identifying (at 610) an advertiser. In some embodiments, the interface manager 520 identifies an advertiser by requiring users that access the web pages to register and login. Users operating as advertisers register as an advertiser and subsequent logins identify the users as advertisers. Alternatively, the interface manager 520 of some embodiments may allow users to identify themselves as advertisers without registration or login. In some embodiments, advertisers 570 logon to different websites hosted by the interface manager 520 than the distributors 575 and power requestors 580.

The interface manager 520 requests (at 620) the advertiser to submit an advertisement and display parameters. Advertisements include audio messages, video messages, graphical messages, textual messages, or any combination thereof. Some examples of display parameters include how often the advertiser desires the advertisement to be disseminated (e.g., disseminate up to a certain price, disseminate twice a day, exclusive advertiser to one or more power stations, etc.) and the regional scope of the advertisement (e.g., a particular business, city, zip code, or nationwide).

The advertisement and display parameters are passed to the advertisement scheduler 540. The advertisement scheduler 540 validates (at 630) the advertisement and display parameters. In some embodiments, validation ensures that the advertisement is properly formatted. For example, validation requires that MMS messages are of a proper file type and the dimensions of an advertisement are suitable for display on displays of portable electronic devices.

The advertisement scheduler 540 calculates (at 640) a payment that is required to disseminate the advertisement based on the display parameters and the advertisement. The interface manager 520 prompts and receives (at 650) payment information from the advertiser. In some embodiments, an invoice is generated and sent to the advertiser. Other billing options include cyclical billing (e.g., monthly billing) or billing the advertiser account every time an advertisement is disseminated.

In some embodiments, video advertisements that run for a duration may be billed higher than text based advertisements. Additionally, the number of pending advertisement in the scheduling queue of the advertisement scheduler 540 may affect the price. For example, the advertisement scheduler 540 may increase the price for disseminating an advertisement during the holiday season as opposed to during off-peak seasons.

The advertisement scheduler 540 schedules (at 660) the advertisement for dissemination within an advertisement queue. The advertisement is stored (at 660) within the advertisement database where it can be retrieved for modification or dissemination and the process 600 ends.

Distributors 575 include power station hosts (e.g., hotels, coffee shops, libraries, etc.). In some embodiments, the power station system operator provides incentives for distributors to host the power stations. For example, a distributor purchases a power station at a fee but receives some of the advertising revenue generated by the power station until the distributor recoups the cost of the power station. Additionally, the distributor may continue receiving some of the advertising revenue or may use the power station as a means to promote other distributor provided services. For example, when users log on to the website of FIG. 4, the advertisement banner may be used to promote goods and services of the distributor (e.g., special hotel room rates, spa services, merchandise, etc.). Accordingly, the website of FIG. 4 may be customized based on the unique identifier of the power station entered on the website of FIG. 3.

Distributors 575 access the web pages of the interface manager 520 to purchase, lease, register, and manage power stations. Distributors 575 are businesses and individuals that operate one or more power stations. Collectively, the distributors 575 form the network of distributed power stations that is controlled by the server 510.

The distributors 575 register the power stations that they host by logging on to a website hosted by the interface manager 520 and providing the unique identifier of a power station that they operate and the location where the power station is hosted. The advertisement scheduler 540 uses the location information to disseminate targeted advertisements to portable electronic devices such that the content of the advertisements are relevant for the viewer. In this manner, distributors 575 may use the power station to exclusively promote their own business. For example, a distributor registers as an advertiser and requests that all advertisements sent to users requesting to unlock the distributor hosted power station contain messages that promote the distributor's own business (e.g., hotel activities, hotel specials, other hotel locations, etc.).

In some embodiments, the advertisement scheduler 540 provides targeted advertisements based on the unique identifier assigned to each power station. The unique identifier is provided within a user request to unlock a particular power station. The advertisement scheduler 540 queries the location database 560 to retrieve a location associated with the unique identifier. The advertisement scheduler 540 queries the advertisement database 550 with the retrieved location to identify one or more advertisements with display parameters that specify that the advertisement should be displayed at the identified location. The advertisement scheduler 540 passes the retrieved advertisement to the interface manager 520 from where it is disseminated to the requesting portable electronic device.

In some embodiments, the distributors 575 specify a rating for each power station that they host. The rating specifies the type of advertisements to be sent by the server 510 to clients of a particular distributor. Higher ratings specify higher end or exclusive clientele and lower ratings specify generic clientele. For example, a four-star hotel power station distributor may register all power stations hosted by the hotel with high ratings. When users of those power stations request unlock codes, the advertisement scheduler 540 uses the unique identifier assigned to those power station to retrieve the rating information. The higher ratings associated with the unique identifiers cause the advertisement scheduler 540 to select advertisements intended for exclusive clientele only. In this manner, general advertisements or advertisements for low end products may be avoided.

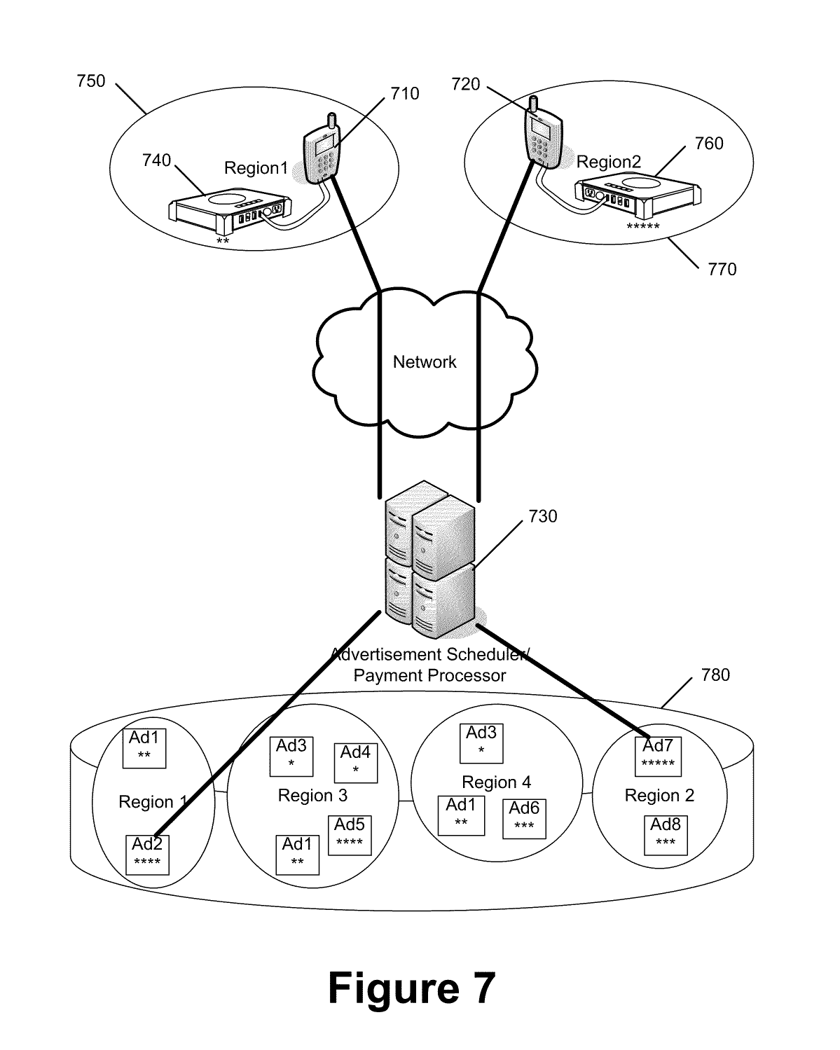

FIG. 7 conceptually illustrates the targeted advertising performed by the advertisement scheduler 540 in accordance with some embodiments. As shown, first and second devices 710 and 720 submit requests for power to the advertisement scheduler 730. The requests include the unique identifier of the first power station 740 located in the first region 750 and the unique identifier of the second power station 760 located in the second region 770. The first power station 740 is registered with a two-star rating and the second power station 760 is registered with a five-star rating. The first region 750 is separate from the second region 770.

The advertisement scheduler 730 receives the requests and identifies the regions and ratings associated with the unique identifiers of each power station from the locations database (not shown). The advertisement scheduler 730 queries the advertisement database 780 to identify advertisements associated with the first region 750 and advertisements associated with the second region 770. The advertisement scheduler 730 identifies Ad1 and Ad2 as advertisements that have display parameters specifying that these advertisements should be displayed to devices located in the first region 750. Similarly, the advertisement scheduler 730 identifies Ad7 and Ad8 as advertisements that have display parameters specifying that these advertisements should be displayed to devices located in the second region 770.

The advertisement scheduler 730 performs another query to the advertisement database 780 based on the ratings associated with each power station 740 and 760. Since the first power station 740 is associated with a two-star rating, Ad1 with a two-star rating and Ad4 with a four-star rating may be sent to the requesting device 710. However, the second power station 760 is associated with a five-star rating and therefore only Ad7 which also contains a five-star rating may be sent to the requesting device 720.

The advertisement scheduler 730 performs a scheduling algorithm to select between the advertisements associated with a particular region. For example, if Ad1 was the last advertisement to be disseminated from region 1, then the advertisement scheduler 730 selects Ad2 as the next advertisement to disseminate device 710 in region 1. For the second power station 760, only Ad7 specifies a rating equal to or greater than that specified for the second power station 760. Accordingly, the advertisement scheduler 730 selects Ad7 to disseminate to device 720. Ad2 is sent via the interface manager of the server to the first device 710 located in the first region 750 and Ad7 is sent via the interface manager of the server to the second device 720 located in the second region 770.

It should be apparent that some advertisements may be displayed across multiple regions. For example, Ad1 may be a national advertisement for a product that is associated with multiple regions as shown in FIG. 7 (i.e., regions 1, 3, and 4). Also, different power stations with different registered ratings may be located in a same region (e.g., premier hotel guests and regular hotel guests).

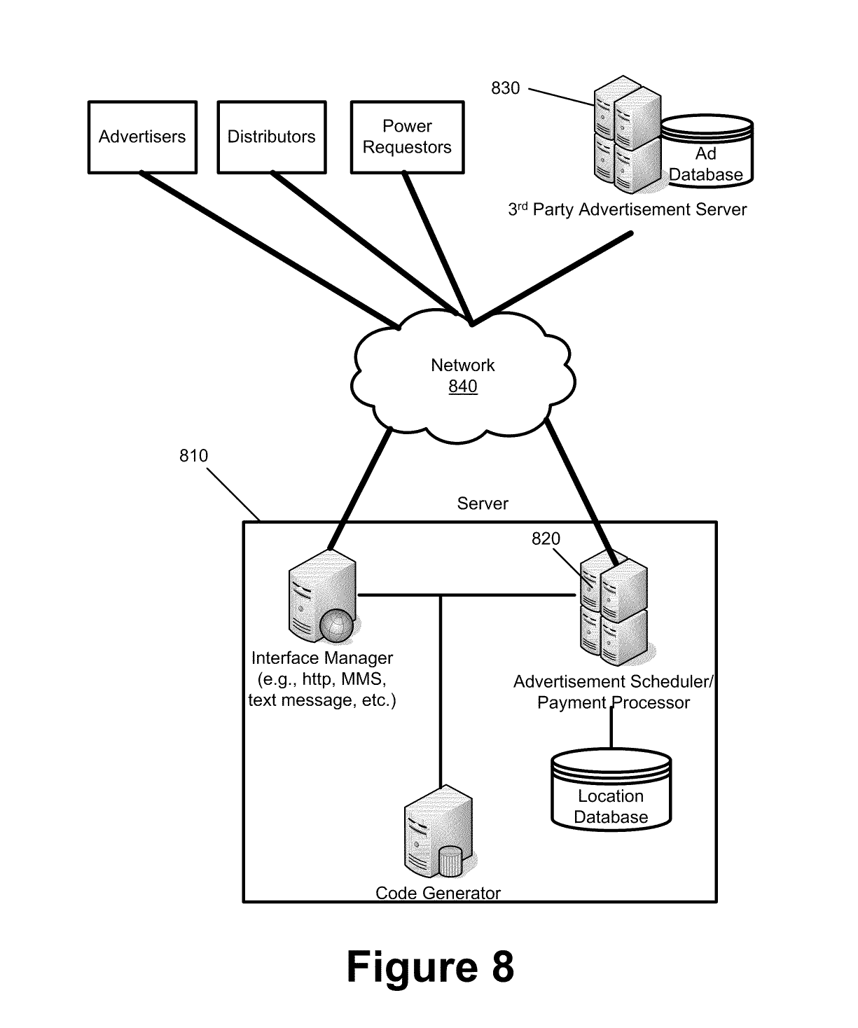

In some embodiments, the advertisements are provided by a third party advertisement server. FIG. 8 illustrates the distributed system architecture of some embodiments that utilize a third party advertisement server. As shown, the distributed power system server 810 no longer includes the advertisement database. Rather, the advertisement scheduler 820 communicates with a third party hosted advertisement server 830 through network 840 to obtain advertisements.

The advertisement scheduler 820 sends advertisement selection parameters to the advertisement server 830 and the advertisement server 830 returns advertisements that meet the parameters of the scheduler 820. In this manner, the advertisement scheduler 820 operates similar to the advertisement scheduler 540 of FIG. 5 by sending location information and rating information in order to receive targeted advertisements from the advertisement server 830.

With reference back to FIG. 5, power requestors 580 access the web pages of the interface manager 520 to request and receive unlock codes to unlock power from particular power stations. In some embodiments, power requestors 580 may submit requests for unlock codes through the interface manager 520 using a website hosted by the interface manager 520, a text message, an MMS message, an email message, or by following a series of audio prompts. In some embodiments, users receive the unlock codes from the interface manager 520 through the same communication means that were used to submit the request.

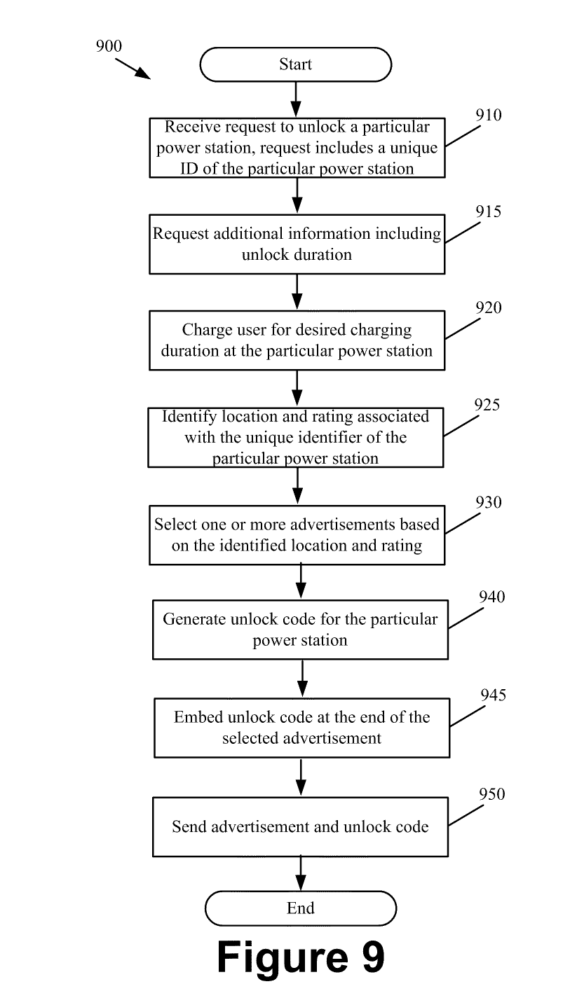

FIG. 9 presents a process 900 for distributing unlock codes on an advertising basis in accordance with some embodiments. The process 900 begins when the interface manager 520 receives (at 910) a request from a portable electronic device to unlock the flow of power at a particular power station. In some embodiments, the request includes the unique identifier of the particular power station. In some other embodiments, the interface manager 520 receives a request to unlock a particular power station without the unique identifier (e.g., logging on to the website of FIG. 3) and the interface manager 520 then prompts the user for the unique identifier.

The interface manager 520 requests (at 915) additional information from the user including a duration that the user desires to receive power to recharge his portable electronic device. Different durations require different fees with larger durations requiring larger fees. Accordingly, the request requires the user to submit login information that provides access to a user account with previously specified billing information. In some embodiments, the request requires the user to submit payment information.

The request passes from the interface manager 520 to the advertisement scheduler 540. The advertisement scheduler 540 charges (at 920) the user for the requested charging duration at the particular power station. As noted above, the user account may be billed, user provided credit card may be charged, a charge may be applied to a room or station where the user is staying, or a promotion code may be used in place of payment.

The advertisement scheduler 540 identifies (at 925) from the location database 560 the location of the particular power station associated with the unique identifier and any associated rating. The advertisement scheduler 540 selects (at 930) one or more advertisements based on the identified location and rating.

The interface manager 520 requests the code generator 530 to generate an unlock code. The code generator 530 generates (at 940) an unlock code for the particular power station and for a particular duration if one was specified in the request.

The selected advertisement and generated unlock code are passed to the interface manager 520. The interface manager 520 embeds (at 945) the unlock code at the end of the advertisement to ensure that the user views the full advertisement before receiving the unlock code. The interface manager 520 sends (at 950) the advertisement with the embedded unlock code to the requesting device and the process 900 ends.

In some embodiments, the interface manager 520 presents the advertisement with the embedded unlock on a web site that is displayed on the display of the requesting device. In some embodiments, the interface manager 520 sends the advertisement with the embedded unlock code to the requesting device via a text message, email, MMS message, or audio message.

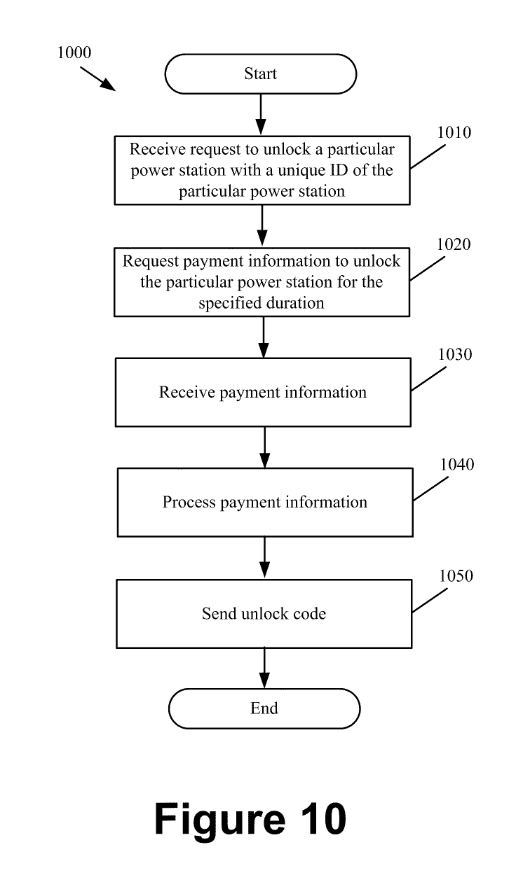

It should be apparent to one of ordinary skill in the art that in some embodiments payment information is optional and that the distributed power system operator and the power station host are compensated only through advertisement revenue. Moreover, some embodiments allow users access to the power of a power station without having to view advertisements. In some such embodiments, the users pay for the power that they acquire from the power station without receiving advertisements. FIG. 10 presents a process 1000 for distributing unlock codes on a fee basis in accordance with some embodiments.

As in FIG. 9, the process 1000 begins when the interface manager 520 receives (at 1010) a request from a portable electronic device to unlock power at a particular power station. The request passes from the interface manager 520 to the advertisement scheduler 540. In some embodiments, the advertisement scheduler 540 also performs payment processing. The advertisement scheduler 540 requests (at 1020) the interface manager 510 to obtain payment information from the user. The advertisement scheduler 540 receives (at 1030) the payment information and processes (at 1040) the payment information. Payment information may include credit card information or a user login that accesses an existing user account with payment information. The advertisement scheduler 540 requests the code generator 530 to send (at 1050) a generated unlock code through the interface manger 510 to the requesting device and the process 1000 ends.

It should be apparent to one of ordinary skill in the art that, though processes 900 and 1000 have been presented as separate processes, the server 510 may perform both processes using the same components (e.g., interface manager 510 and advertisement scheduler 540) or similar components. Accordingly, the server 510 allows some users to access power on an advertisement and fee basis, advertisement basis only, or fee basis only.

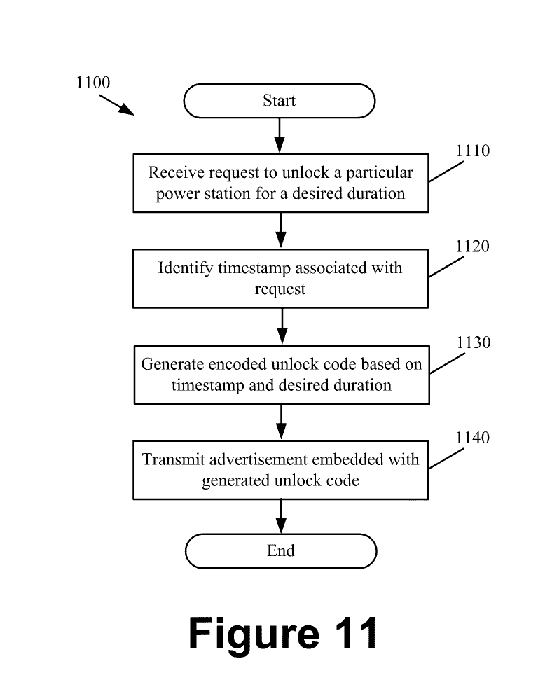

FIG. 11 presents a process 1100 performed by the code generator 530 for generating an unlock code for a particular power station. The process 1100 commences by the code generator 530 receiving (at 1110) a request to unlock a particular power station for a desired duration. The code generator 530 identifies (at 1120) a timestamp associated with the request (e.g., current time). The code generator 530 executes an code generation algorithm to generate (at 1130) an encoded unlock code based on the timestamp and the desired duration. The generated code is embedded with an advertisement that is transmitted (at 1140) to the requesting device through the interface manager 510 and the process 1100 ends.

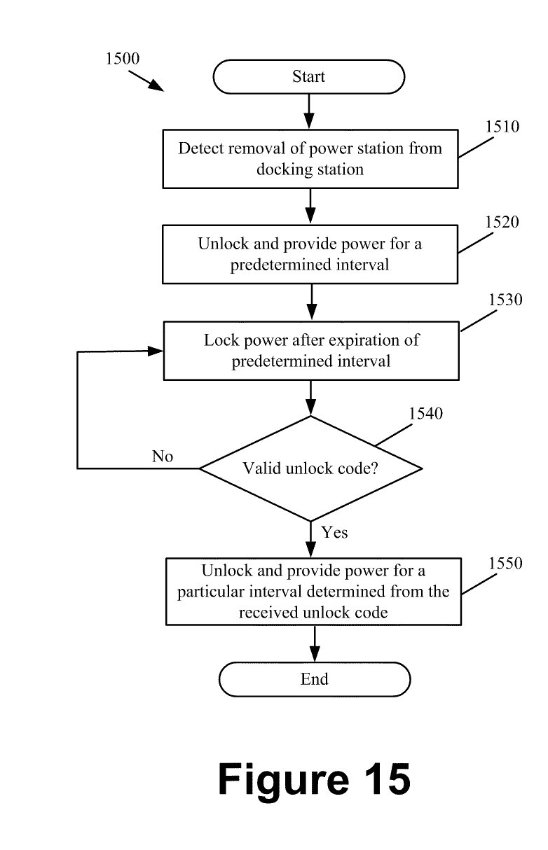

The unlock code is encoded so that the power station can validate the unlock code. This ensures that the user has viewed an advertisement or has paid to access power from the power station and that unauthorized users are prevented from accessing power from the power station. As described in further detail below with reference to FIG. 15, the power station executes a decoding algorithm to extract the timestamp and duration parameters from the encoded unlock code. If the extracted timestamp from a user entered unlock code is within a time threshold (e.g., ten minutes) of a current timestamp maintained by the power station, the power station unlocks the flow of power for the specified duration. However, if the encoded timestamp parameter is invalid, the power station knows that the user is improperly trying to access power from the power station without having viewed an advertisement or having paid to access the power. In such situations, the power station continues to lock the flow of power.

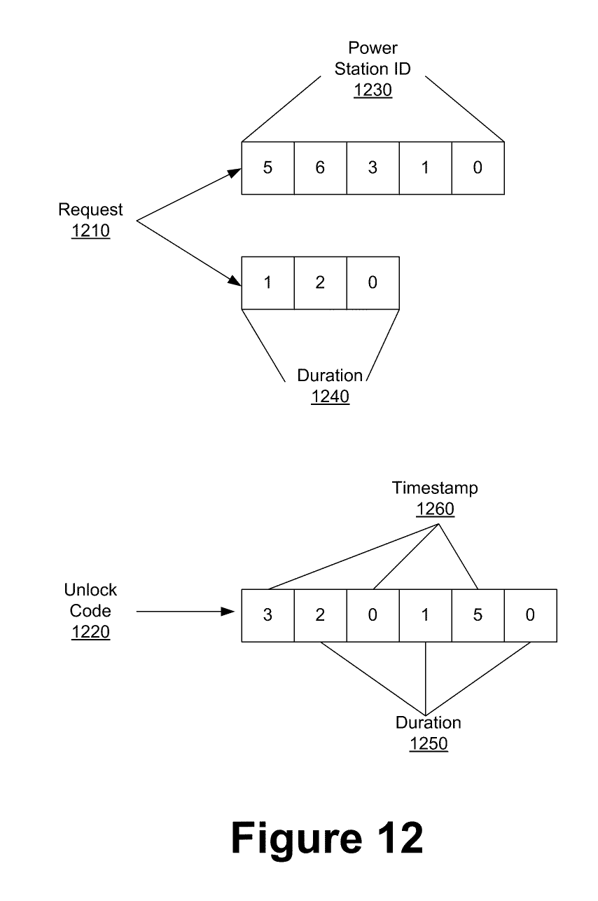

FIG. 12 illustrates an example of a request 1210 for an unlock code and generation of the encoded unlock code 1220 by the code generator 530 in accordance with some embodiments. As shown, the request 1210 includes two sets of. The request 1210 includes the unique identifier of the power station 1230 which is depicted as a five digit number. The request 1210 further includes a three digit duration 1240 that specifies a desired amount of power in minutes (e.g., 120 minutes). It should be apparent to one of ordinary skill in the art that the request 1210 need not include the duration field when a default duration of power is provided by the power station. The sets of numbers 1210 and 1220 allow the request to be submitted using a web interface, email, text message, or audio prompts. However, it should be apparent that the request 1210 is exemplary of some embodiments and that some other embodiments may utilize a request of a different form or format.

The unlock code 1220 is presented as a six digit number with the three digits of the duration 1250 encoded with three digits of a timestamp 1260. The encoding is unrecognizable by a user and therefore control over the unlocking of the power stations is retained by the server 510. It should be apparent to one of ordinary skill in the art that the unlock code may include fewer or additional digits. For example, the unlock code may include a four digit timestamp. The timestamp may also be modified to include additional parameters for configuring the power station. For example, the voltage (e.g., 1.5V or 3V) or amount of current of the power station can be configured with the unlock code. In this manner, the power station can be configured to provide power within the power specifications of particular devices.

III. Power Station

Each of the power stations may be individually owned, operated, or leased from the distributed power system operator. The power stations are deployed across various regions in locales where it is advantageous to provide portable power to users with portable electronic devices. Accordingly, power stations may be located at hotels, coffee shops, restaurants, resorts, libraries, cruise ships, parks, or other such locations where power outlets may be unavailable, device power adapters are incompatible with electrical systems, or users are unlikely to carry power adapters or spare batteries with them.

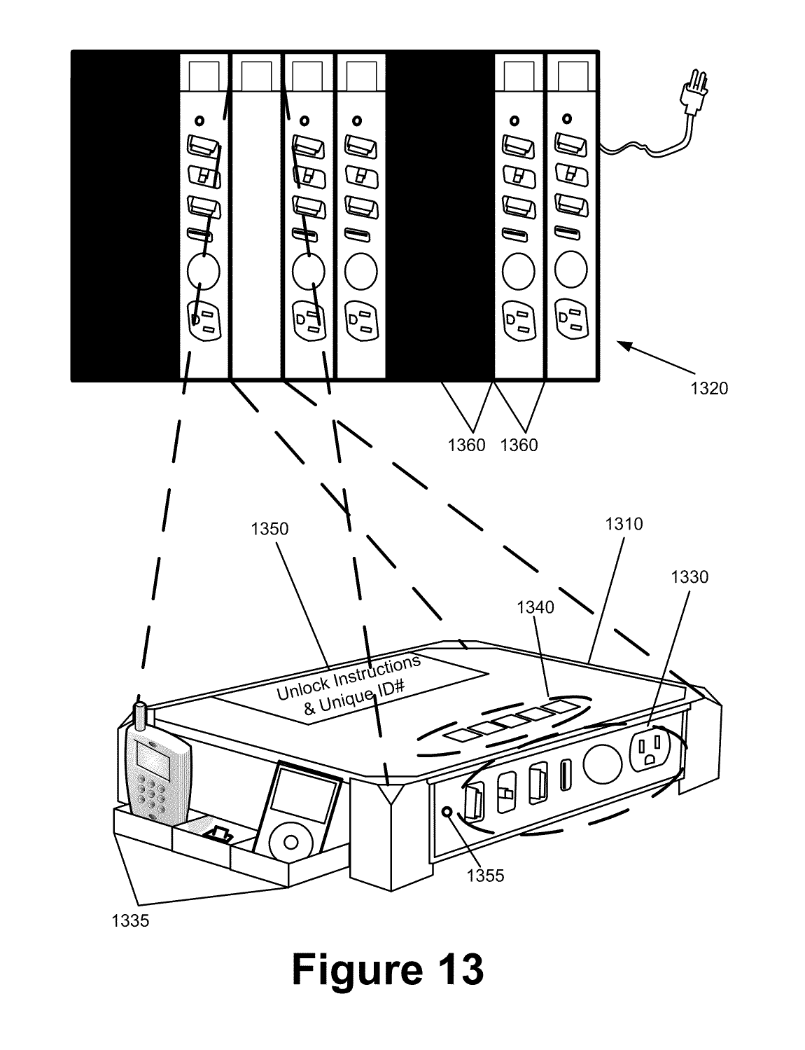

FIG. 13 presents a power station 1310 in accordance with some embodiments. The power station 1310 is extracted from a recharging station 1320. The power station 1310 includes wired device interfaces 1330, docking interfaces 1335, input entry 1340, instructions for unlocking power and a unique identifier for identifying the power station 1350, and a status indicator 1355.

The power station 1310 is housed within the recharging station 1320 when the power station 1310 is not in use. The recharging station 1320 includes a power cord that supplies power from a wall outlet to a battery or power supply of the power station 1310 through recharging slots 1360. The power from the recharging station 1320 recharges the power supply of the power station 1310 so that the battery of the power station 1310 remains charged and ready to be used to supply power to other portable electronic devices. In some embodiments, the recharging station 1320 includes ten recharging slots 1360 to recharge ten different power stations. When a user desires to recharge a portable electronic device, a power station is slide out from a recharging slot 1360 and transported to a user wherever the user may be located. When the user is done with the power station, the power station is slid back into a recharging slot 1360 where it is recharged.

The power station 1310 includes multiple wired interfaces 1330 to supply power to a variety of portable electronic devices with different charging interfaces. In some embodiments, each of the wired interfaces includes a retractable cord with a different interface connector at the end of the cord. The cord can be pulled out from the power station 1310 up to a distance of three feet and locked into position. A subsequent pull causes a spring loaded mechanism to retract the cord back into the power station 1310.

The power station 1310 further includes multiple docking interfaces 1335 to supply power to a variety of portable electronic devices with different charging interfaces. The docking interfaces 1335 include multiple cradles each with a different device charging interface. To recharge a portable electronic device using a docking interface 1335, the user slides the device into the cradle and the charging interface of the cradle attaches to the charging interface of the device. The power station 1310 is then able to transfer power from its power supply to the device. It should be apparent to one of ordinary skill in the art that some embodiments include only the wired interfaces 1330, some embodiments include only the docking interfaces 1335, and some embodiments include a combination of both.

In some embodiments, the wired interface 1330 and the docking interfaces 1335 include common interfaces such as a standard three prong outlet interface, a standard two prong outlet interface, any USB based interface (e.g., mini-USB, micro-USB, or standard USB), car cigarette lighter socket, and any Apple™ based interface (e.g., iPod™, iPod nano, iPod mini, iPhone™, and iPad™). It should be apparent to one of ordinary skill in the art that a particular power station may include more or less interfaces.

Additionally, some embodiments include an induction charging interface through which power is wirelessly transferred from the power station 1310 to a battery of a nearby device. In some such embodiments, the device to be recharged is placed on top of the power station 1310 or nearby and power is transmitted wirelessly to the battery of the device thereby recharging the device.

The portability of the power station 1310 allows recharging of portable electronic devices irrespective of where the device is located. For example, the power station 1310 may be transferred from a hotel lobby to poolside where the power station 1310 recharges a client's portable electronic device without requiring the client to be near a wall outlet or have the client bring a charging adapter.

In some embodiments, the power station 1310 provides a predetermined duration (e.g., twelve minutes) of free power when detached from the recharging station 1320. This free period temporarily revives a user device with no or little battery power and allows the user to request an unlock code using the device in order to receive further power to recharge the device.

The input entry 1340 provides a keypad through which users can enter an unlock code. In some embodiments, the input entry 1340 is a numeric keypad. The keypad may include separate keys for the numbers 0-9, may combine multiple numbers to a single key, or may include separate keys for fewer digits.

The status indicator 1355 presents status notifications to notify a user when a valid unlock code has been entered or when an invalid unlock code has been entered. Similarly, the status indicator 1355 may be used to notify users when the power supply is locked or unlocked. The status indicator 1355 includes a light that presents status by turning on the light, turning off the light, or flashing the light for different durations or speeds. The status indicator 1355 may also include audible notifications, such as beeps, to notify a user of various status changes.

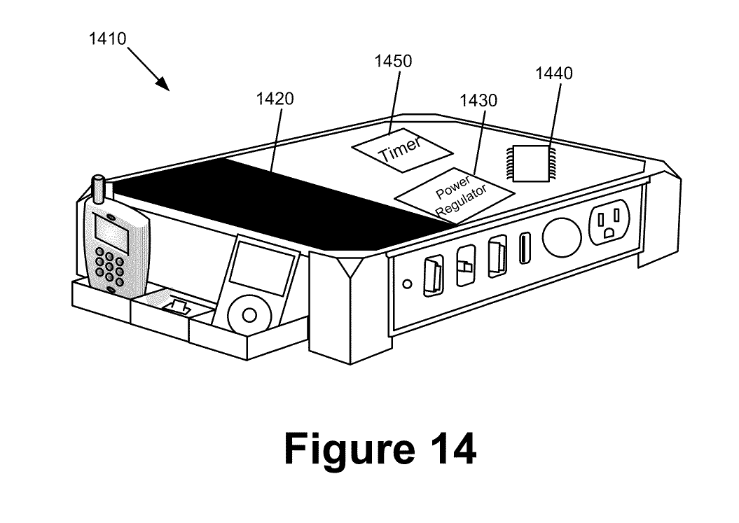

FIG. 14 presents the internal components of the power station 1410 in accordance with some embodiments. In FIG. 14, the power station 1410 includes a battery 1420, power regulator 1430, processor 1440, and timer 1450. The battery 1420 is a high capacity rechargeable battery capable of recharging multiple electronic devices for several hours. In some embodiments, the battery 1420 contains 36,000 mAh of power and has a cycle life of 500 cycles before the distributed power system operator replaces the batteries. However, it should be apparent that the battery 1420 may have a longer life cycle without impacting functionality of the power station.

The power regulator 1430 regulates the outflow of power from the battery 1420. In some embodiments, the power regulator 1430 regulates power according to the requirements of a device or electrical system of a country. For example, some countries utilize 220V electrical systems and portable electronic devices used in those countries require 220V for charging. Therefore, the power regulator 1430 provides power at 220V. Other countries utilize 110V electrical systems and portable electronic devices used in those countries require 110V for charging. Therefore, the power regulator 1430 provides power at 110V. The power regulator 1430 similarly regulates the current or amperage. Too little current or voltage and the device does not get charged. Too much current or voltage could damage the electronics or battery of the device.

In some embodiments, the power regulator 1430 contains a user adjustable switch with which a user can select a voltage and/or current suitable for the device to be charged. In some other embodiments, the power regulator 1430 automatically adjusts the voltage and current based on parameters detected from the device. Automatic adjustments may be made upon entry of an unlock code that contains a value specifying voltage and current specifications. These values may be encoded into the unlock code by having the interface manager of the server request the user to identify the device to be charged. The user identifies a make and model of the device and power settings associated with the device are encoded within the unlock code. Alternatively, the power regulator 1430 may utilize a default voltage and current that is safe for most portable electronic devices in the region in which the power station 1410 is located.

In some embodiments, the power regulator 1430 operates in conjunction with the processor 1440. For example, the processor 1440 decodes an unlock code with power settings and the processor 1440 adjusts settings of the power regulator 1430 based on the decoded values. The processor 1440 is also responsible for locking and unlocking power from the battery 1420 and processing unlock codes entered on the input entry keypad.

FIG. 15 presents a process 1500 performed by the processor 1440 of the power station 1410 to unlock power in accordance with some embodiments. The process 1500 begins when the processor 1440 detects (at 1510) that the power station 1410 has been removed from the docking station so as to provide a predetermined interval of free power. The processor 1440 uses the timer 1450 to unlock (at 1520) the flow of power from the battery 1420 for the predetermined interval. The processor 1440 identifies the end of the free power period when an interrupt is received from the timer 1450. The processor locks (at 1530) the flow of power from the battery 1420 preventing a device that is connected to any of the charging interfaces from receiving any further power until a valid unlock code is provided.

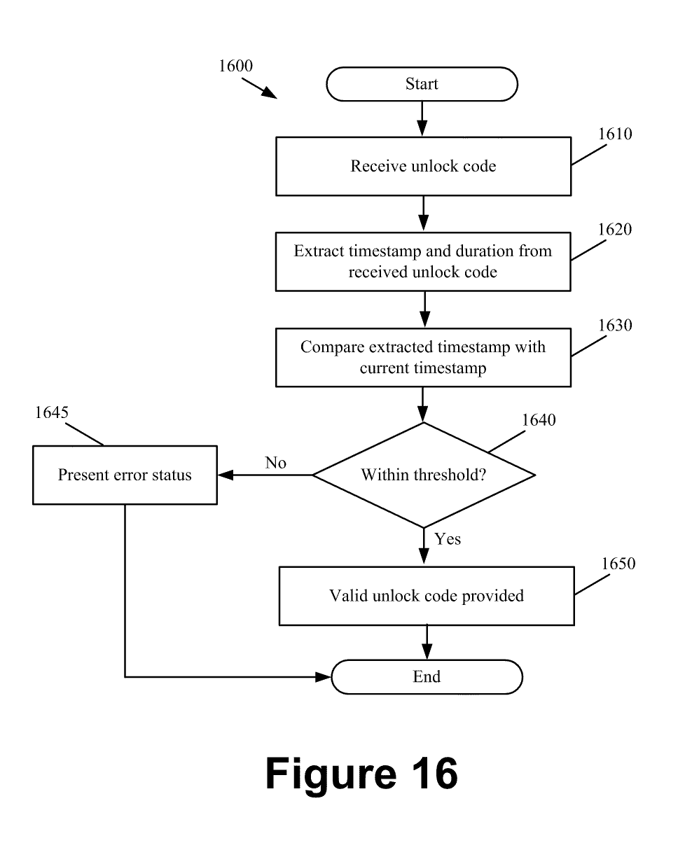

The processor 1440 identifies when a user enters an unlock code using the input entry and validates (at 1540) the provided unlock code. To validate the code, the processor 1440 performs the process 1600 as shown in FIG. 16.

Process 1600 begins when the processor 1440 receives (at 1610) an unlock code from the input entry. The processor 1440 executes a decoding algorithm to extract (at 1620) parameters from the user entered unlock code. In some embodiments, the processor 1440 extracts a timestamp value and a duration value. The timestamp value identifies when the unlock code was generated by the server. The duration value specifies how long to unlock the power station and provide charging to any devices connected to any of the multiple interfaces of the power station.

The processor 1440 compares (at 1630) the extracted timestamp value against a current timestamp value maintained by the timer 1450. Specifically, the processor 1440 verifies that the extracted timestamp value from the unlock code is within a time threshold (e.g., ten minutes) of the current timestamp value provided by the timer 1450. Accordingly, users have the time threshold from when they receive the unlock code from the server to enter the code into the power station.

When the extracted timestamp value is not within the threshold, the processor 1440 causes (at 1645) an error status indicator to become active and the process 1600 ends which further causes the processor 1440 to continue locking (at 1530) the power in process 1500 of FIG. 15. Otherwise, the processor 1440 has identified (at 1650) a valid unlock code which causes the processor 1440 to unlock (at 1550) power from the battery 1420 in process 1500 of FIG. 15. The processor 1440 sets the timer 1450 to provide power until the duration period extracted from the unlock code expires at which time the processor 1440 again locks power. The process 1500 ends unless another unlock code is entered or the power station is docked and undocked from the docking station.

It should be apparent that the processor 1440 performs additional functionality in addition to those described above. For example, the processor 1440 performs management functions for the power station such as controlling status indicators of the power station 1420.

Accordingly, some embodiments provide systems, methods, and devices for recharging electronic devices through a distributed network of portable power stations that provide power on an advertising or fee basis. In this manner, advertisers are provided a new medium through which to promote their businesses, products, and services. Users of portable electronic devices have an accessible and portable means through which they can recharge their portable electronic devices irrespective of their location, whether they brought their various charging adapters, whether they are carrying extra batteries, or whether they have funds to pay for the power. The power stations provide portable means for transporting power to the users. Moreover, the server ensures that an advertising and marketing system is in place to compensate the power distribution service provider as well as individual power station distributors and parties hosting the power stations. As a result, users no longer have to worry about their portable electronic devices running out of power.

While the invention has been described with reference to numerous specific details, one of ordinary skill in the art will recognize that the invention can be embodied in other specific forms without departing from the spirit of the invention. Thus, one of ordinary skill in the art understands that the invention is not to be limited by the foregoing illustrative details, but rather is to be defined by the appended claims.

I claim:

1. A power distribution system comprising:
a server for communicating with a plurality of electronic devices, wherein said communication comprises (i) receiving a request to unlock power and (ii) sending an advertisement and a code to unlock said power; and
a plurality of distributed portable power stations, each portable power station comprising a plurality of charging interfaces and a lockable power supply that is unlocked using the server provided code, wherein unlocking said power supply recharges a battery of at least one electronic device connected to one of the plurality of charging interfaces.

2. The power distribution system of claim 1, wherein said communication further comprises processing payment information at said server.

3. The power distribution system of claim 1, wherein said communication further comprises specifying said request through a set of web pages generated by said server.

4. The power distribution system of claim 1, wherein said communication further comprises at least one of a set of text messages, emails, multimedia messaging services (MMS) messages, and audio messages.

5. The power distribution system of claim 1 further comprising a network to facilitate communications between said server and the plurality of electronic devices.

6. The power distribution system of claim 1, wherein the plurality of charging interfaces comprises at least two of a three prong outlet interface, two prong outlet interface, cigarette lighter socket, universal serial bus (USB) based interface, and an Apple™ based interface.

7. A power distribution system comprising:
a plurality of power stations distributed across a plurality of locations, each power station comprising a lockable power supply that is unlocked by entry of a code;
an advertisement server for providing a plurality of advertisements to a plurality of users that request unlock codes in order to receive power from said power stations, wherein said advertisement server provides an advertisement to a particular user based on a location of a particular power station that the particular user requests to unlock; and
a code generator for generating codes to unlock power from said power stations, wherein a generated code is disseminated along with an advertisement to the particular user to unlock power from the particular power station.

8. The power distribution system of claim 7 further comprising a database to store locations associated with each power station of the plurality of power stations.

9. The power distribution system of claim 7 further comprising an interface server for disseminating said advertisements and codes using at least one of a set of web page, emails, text messages, MMS messages, and audio messages.

10. The power distribution system of claim 7, wherein the advertisement server is further for receiving user submitted advertisements.

11. A method for distributing power on an advertisement basis through a plurality of distributed portable power stations, wherein said power stations comprise a lockable power supply that is unlocked to provide power using a code, the method comprising:
receiving a request from an electronic device to unlock power from a particular power station of the plurality of power stations;
selecting an advertisement from a plurality of advertisements to send to said electronic device based on a location associated with the particular power station;
generating an unlock code to unlock power from the particular power station; and
sending the selected advertisement and the generated unlock code to the electronic device to facilitate a flow of power from the particular power station to recharge a battery of any electronic device connected to the particular power station.

12. The method of claim 11, wherein generating the unlock code comprises generating an encoded code comprising a timestamp value and a duration value.

13. The method of claim 11, wherein receiving the request comprises receiving a unique identifier associated with the particular power station, wherein each power station of the plurality of power stations is assigned an identifier that is unique to identifiers assigned to other power stations.

14. The method of claim 11 further comprising unlocking power at the particular power station to recharge any device connected to the particular power station upon receiving the unlock code.

15. The method of claim 11 further comprising embedding the unlock code within said selected advertisement before sending said advertisement.

16. A portable battery recharging station comprising:
a plurality of charging interfaces for connecting to different interfaces of a plurality of electronic devices;
a lockable power supply;
an input entry to receive user entered codes; and
a processor for (i) validating a user entered code received at the input entry, (ii) unlocking said power supply to enable the flow of power to recharge batteries of any device connected to any of the plurality of charging interfaces when said code is valid, and (iii) locking said power supply to cut off the flow of power to the plurality of charging interfaces when said code is invalid or expires.

17. The portable battery recharging station of claim 16 further comprising a timer to notify the processor to relock the power supply when a specified charging period expires.

18. The portable battery recharging station of claim 16, wherein the code received at the input entry is encoded, wherein the processor is further for decoding said code to extract a timestamp value and a duration value.

19. The portable battery recharging station of claim 18, wherein the processor validates a code by comparing the extracted timestamp value to a current timestamp value, wherein said code is valid when the extracted timestamp value is within a time threshold of the current timestamp value.

20. The portable battery recharging station of claim 16, wherein the plurality of charging interfaces comprises at least two of a three prong outlet interface, two prong outlet interface, cigarette lighter socket, universal serial bus (USB) based interface, and an iPod™ based interface.

21. The portable battery recharging station of claim 16 further comprising a plurality of docking ports, each particular docking port comprising a cradle to support an electronic device and a particular charging interface to recharge an electronic device with the particular charging interface when said device is placed on the particular docking port.

22. The portable battery recharging station of claim 16 further comprising an induction charger for wirelessly charging batteries of a nearby electronic device when said power supply is unlocked.

23. The portable battery recharging station of claim 16, wherein the plurality of charging interfaces comprises a plurality of retractable cords each with a different interface connector.

24. The portable battery recharging station of claim 16 further comprising a power regulator for adjusting at least one of a voltage and current supplied by the power supply, wherein said processor is further for adjusting the voltage or current of the power regulator.

25. A method for distributing power using a portable power station comprising a lockable power supply, the method comprising:
receiving an unlock code at an input keypad of the portable power station;
decoding said unlock code to extract a timestamp value and a duration value from said unlock code;
validating said unlock code by comparing said timestamp value to a time threshold and a current timestamp value maintained within said portable power station;
unlocking said power supply to provide power for the extracted duration value when said unlock code is valid; and
locking said power supply to cut off power from the power supply when said unlock code is invalid.

26. The method of claim 25 further comprising detecting a removal of the portable power station from a docking station and unlocking said power supply for a predetermined interval upon detecting the removal of the portable power station from the docking station.
